(19) United States
(12) Patent Application Publication
(10) Pub. No.: US 2009/0274302 A1
(43) Pub. Date: Nov. 5, 2009

(54) METHOD FOR DERIVING TRAFFIC ENCRYPTION KEY

(75) Inventors: Lin-Yi Wu, Taipei County (TW); Chi-Chen Lee, Taipei City (TW); I-Kang Fu, Kaohsiung County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/432,841

(22) Filed: Apr. 30, 2009

Related U.S. Application Data
(60) Provisional application No. 61/048,965, filed on Apr. 30, 2008.
(60) Provisional application No. 61/051,819, filed on May 9, 2008.
(60) Provisional application No. 61/053,041, filed on May 14, 2008.

(51) Int. Cl. H04K 1/00; H04W 36/00; H04L 9/32

(52) U.S. Cl. 380/272; 455/436; 713/170

(57) ABSTRACT

A mobile station is provided. The mobile station includes one or more radio transceiver module and a processor. The processor performs a handover negotiation procedure with a serving base station so as to handover communication services to a target base station by transmitting and receiving a plurality of handover negotiation messages via the radio transceiver module, and generates an Authorization Key (AK) context and derives at least one Traffic Encryption Key (TEK) for the target base station. The AK context includes a plurality of keys shared with the target base station for encrypting messages to be transmitted to the target base station, and the TEK is a secret key shared with the target base station for encrypting traffic data.

### CROSS REFERENCE TO RELATED APPLICATIONS

This application claims the benefit of U.S. Provisional Application No. 61/051,819 filed 2008 5, 9 and entitled “TEK UPDATE IN HO”, U.S. Provisional Application No. 61/048,965 filed 2008 4, 30 and entitled “KEK AND TEK GENERATION FOR ACCELERATE DATA TRANSFER IN HO”, and U.S. Provisional Application No. 61/053,041 filed 2008 5, 14 and entitled “TEK UPDATE IN HO-NEGOTIATION AND CONFIRMATION”. The entire contents of which are hereby incorporated by reference.

### BACKGROUND OF THE INVENTION

1. Field of the Invention

The invention relates to a method for deriving a Traffic Encryption Key (TEK), and more particularly to a method for deriving a TEK in a seamless handover procedure.

2. Description of the Related Art

In a wireless communication system, a base station provides services to terminals in a geographical area. The base station usually broadcasts information in the air interface to aid terminals in identifying necessary system information and service configurations so that essential network entry information can be gained and determination of whether to use services provided by the base station may be provided.

In WiMAX (Worldwide Interoperability for Microwave Access) communication systems, or IEEE 802.16-like systems, if data encryption is negotiated between base station and terminal, traffic data is allowed to be transmitted after the TEK is generated. The TEK is a secret key used to encrypt and decrypt the traffic data. The base station randomly generates the TEK, encrypts the TEK by the KEK (Key Encryption Key) and distributes the encrypted TEK to the terminal. The KEK is also a secret key shared between the terminal and the base station. The KEK is derived by the terminal and base station individually according to a predetermined algorithm. After receiving the encrypted TEK from the base station, the terminal decrypts the TEK by the KEK. The terminal encrypts the traffic data by the TEK after obtaining the TEK and transmits the encrypted traffic data to the base station.

Conventionally, during an optimized handover procedure, the target base station generates the TEK after receiving a ranging request message from the terminal, and responds with the encrypted TEK to the terminal via a ranging response message. However, traffic data transmission is inevitably interrupted during the time period after a handover message is sent, and until the TEK is received and decrypted. A long interruption time period seriously degrades the quality of the communication service. Thus, a novel TEK generation method and a substantially seamless handover procedure are highly required.

### BRIEF SUMMARY OF THE INVENTION

A Mobile Station (MS), a Base Station (BS) and a method for deriving a Traffic Encryption Key (TEK) are provided. An embodiment of a MS comprises a radio transceiver module and a processor. The processor performs a handover negotiation procedure with a serving base station so as to handover communication services to a target base station by transmitting and receiving a plurality of handover negotiation messages via the radio transceiver module, and generates an Authorization Key (AK) context and derives at least one Traffic Encryption Key (TEK) for the target base station. The AK context includes a plurality of keys shared with the target base station for protecting the information transmission with the target BS, and the TEK is a secret key shared with the target BS for encrypting traffic data without key distribution.

An embodiment of a method for generating at least one TEK shared between a MS and a BS without key distribution in a wireless communication system comprises: obtaining at least one key and information shared between the mobile station and the base station; and generating the TEK according to the information and the key via a predetermined function.

An embodiment of a BS in a wireless communication network comprises a network interface module, one or more radio transceiver module and a processor. The processor receives a handover indication message from a network device in the wireless communication network via the network interface module, generates an AK context and derives at least one TEK for a MS after receiving the handover indication message, receives an authentication message from the MS via the radio transceiver module, and verifies consistency of the TEK and a TEK generated by the MS according to the received authentication message. The handover indication message is a message to indicate that the communication service of the MS provided by the network device is to be transferred to the BS. The authentication message is a message for the MS to authenticate its identity. The TEK is a secret key shared with the MS for encrypting traffic data.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows an exemplary network topology of a wireless communication system according to an embodiment of the invention;

FIG. 2 shows a schematic view of a base station according to an embodiment of the invention;

FIG. 3 shows a schematic view of a mobile station according to an embodiment of the invention;

FIG. 4 shows a schematic diagram illustrating an AK context generation procedure according to an embodiment of the invention;

FIG. 5 shows a schematic diagram illustrating the initial network entry and handover operation procedures according to an embodiment of the invention;

FIG. 6 shows a schematic diagram of a communication network for illustrating the TEK generation concept according to an embodiment of the invention;

FIG. 7 shows the message flows of initial network entry and handover operation procedures according to an embodiment of the invention;

FIG. 8 shows the message flows of initial network entry and handover operation procedures according to an embodiment of the invention;

FIG. 9 shows the message flows of initial network entry and handover operation procedures according to an embodiment of the invention;

FIG. 10 shows the message flows of initial network entry and handover operation procedures according to an embodiment of the invention;

FIG. 11 shows the message flows of initial network entry and handover operation procedures according to an embodiment of the invention;

FIG. 12 shows the message flows of handover operation procedures according to an embodiment of the invention; and

FIG. 13 shows the message flows of handover operation procedures according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

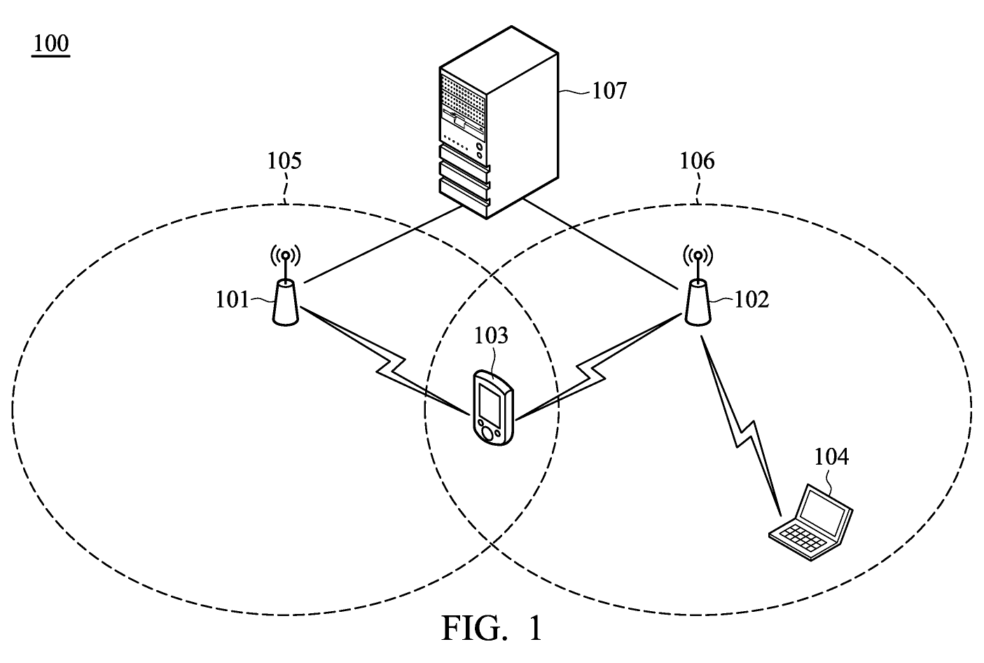

FIG. 1 shows an exemplary network topology of a wireless communication system according to an embodiment of the invention. As shown in FIG. 1, the wireless communication system 100 comprises one or more Base Stations (BS) 101 and 102 in one or more sectors 105 and 106 that receive, transmit, repeat, etc., wireless communication signals and provide services to each other and/or to one or more Mobile Stations (MS) 103 and 104. The wireless communication system 100 further comprises one or more network device 107 in the backbone network (also referred as a Core Network (CN)) that communicates with the BSs to provide and maintain services for the BSs. According to an embodiment of the invention, the MS may be a mobile phone, a computer, a notebook, a PDA, a CPE . . . etc., and thus, the invention should not be limited thereto. BSs 101 and 102 may be connected to an infrastructure network (e.g. the Internet) and, therefore, provide connectivity to the Internet. According to one embodiment of the invention, the BSs 101 and 102 may facilitate peer-to-peer communication service (e.g. communication directly between MSs 103 and 104). According to the embodiment of the invention, the wireless communication system 100 may be configured as a WiMAX communication system or adopt technologies based on one or more specifications defined in the series of IEEE 802.16 related standards.

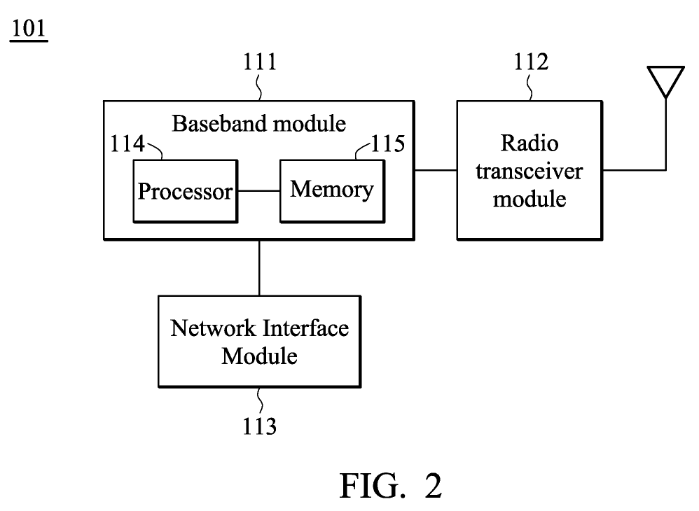

FIG. 2 shows a schematic view of a BS according to an embodiment of the invention. The BS 101 may comprise a baseband module 111 a radio transceiver module 112 and a network interface module 113. The radio transceiver module 112 may comprise one or more antennas, a receiver chain to receive wireless radio frequency signals and convert the received signals to baseband signals to be processed by the baseband module 111, and a transmitter chain to receive baseband signals from the baseband module 111 and convert the received signals to wireless radio frequency signals to be transmitted to the air interface. The radio transceiver module 112 may comprise a plurality of hardware devices to perform radio frequency conversion. The network interface module 113 is coupled to the baseband module 111 and used to communicate with the network devices in the backbone network, such as the network device 107 as shown in FIG. 1. The baseband module 111 further converts the baseband signals to a plurality of digital signals, and processes the digital signals, and vice versa. The baseband module 111 may also comprise a plurality of hardware devices to perform baseband signal processing. The baseband signal processing may comprise Analog to Digital Conversion (ADC)/Digital to Analog Conversion (DAC), gain adjustments, modulation/demodulation, encoding/decoding, and so on. The baseband module 111 further comprises a processor 114 and a memory 115. In order for the mobile stations 103 and 104 to access BSs 101 and 102 and use the offered services, or to utilize the spectrum for wireless communications, BSs 101 and 102 broadcast certain system information. The memory 115 may store the system information of the base station 101, and further store a plurality of software/firmware code or instructions to provide and maintain the wireless communication services. The processor 114 executes the code and/or instructions stored in the memory 115, and controls the operations of memory 115, the baseband module 111 and the radio transceiver module 112.

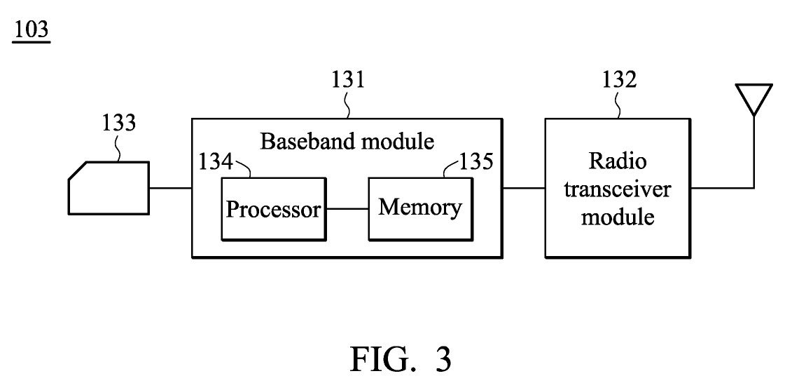

FIG. 3 shows a schematic view of a MS according to an embodiment of the invention. The MS 103 may comprise a baseband module 131, a radio transceiver module 132 and selectively comprise a subscriber identity card 133. The radio transceiver module 132 receives wireless radio frequency signals, converts the received signals to baseband signals to be processed by the baseband module 131, or receives baseband signals from the baseband module 131 and converts the received signals to wireless radio frequency signals to be transmitted to a peer device. The radio transceiver module 132 may comprise a plurality of hardware devices to perform radio frequency conversion. For example, the radio transceiver module 132 may comprise a mixer to multiply the baseband signals with a carrier oscillated at the radio frequency of the wireless communication system. The baseband module 131 further converts the baseband signals to a plurality of digital signals, and processes the digital signals, and vice versa. The baseband module 131 may also comprise a plurality of hardware devices to perform baseband signal processing. The baseband signal processing may comprise analog to digital conversion (ADC)/digital to analog conversion (DAC), gain adjustments, modulation/demodulation, encoding/decoding, and so on. The baseband module 131 further comprises a memory device 135 and a processor 134. The memory 135 may store a plurality of software/firmware code or instructions to maintain the operation of the MS. It is to be noted that the memory device 135 may also be configured outside of the baseband module 131 and the invention should not be limited thereto. The processor 134 executes code or the instructions stored in the memory 135 and controls the operations of the baseband module 131, the radio transceiver module 132, and the plugged subscriber identity card 133, respectively. The processor 134 may read data from the plugged subscriber identity card 133 and writes data to the plugged subscriber identity card 133. It is also to be noted that the MS 103 may also comprise other types of identity module instead of the subscriber identity card 133 and the invention should not be limited thereto.

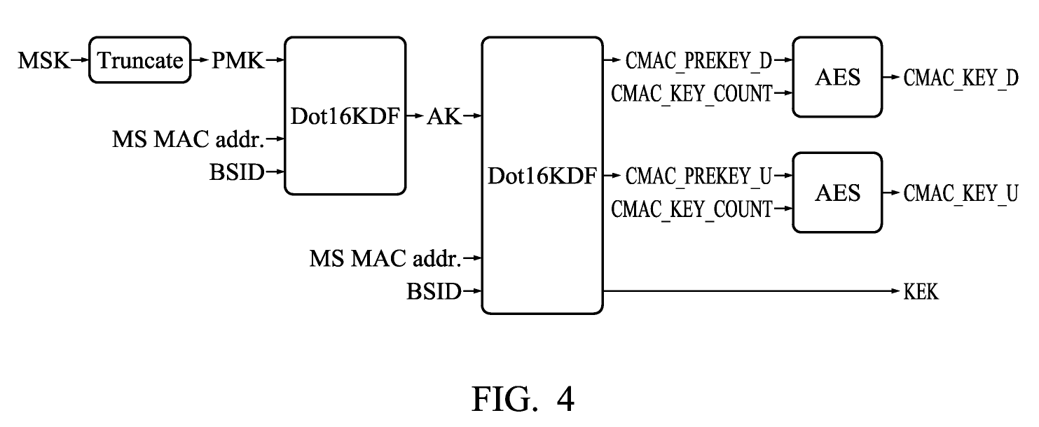

In accordance with protocols defined by WiMAX standards, including IEEE 802.16, 802.16d, 802.16e, 802.16m, and the likes, the BS and the terminal (also referred to as the Mobile Station (MS)) identify communication parties through an authentication procedure. As an example, the procedure may be done by Extensible Authentication Protocol based (EAP-based) authentication. After authentication, an Authorization Key (AK) context is derived by the MS and BS, respectively, so as to be used as a shared secret in encryption and integrity protection. The AK context comprises a plurality of keys for message integrity protection. FIG. 4 shows a schematic diagram illustrating an AK context generation procedure according to an embodiment of the invention. A Master Session Key (MSK) is firstly generated via the EAP-based authentication. The MSK is an unique key shared between the MS and BS. The MSK is truncated to generate the Pairwise Master Key (PMK), and the AK is then generated via the Dot16KDF operation according to the PMK, MS Media Access Control layer (MAC) address and the Base Station Identifier (BSID). Two pre-keys CMAC_PREKEY_D and CMAC_PREKEY_U and a Key Encryption Key (KEK) are then generated via the Dot16KDF operation according to the AK, MS MAC address and the BSID. The KEK is also a secret key shared between the MS and the BS for encrypting Traffic Encryption Key (TEK). Finally, two message authentication keys CMAC_KEY_U and CMAC_KEY_D for protecting the integrity of uplink and downlink management message are generated via the Advanced Encryption Standard (AES) operation according to the pre-keys CMAC_PREKEY_D and CMAC_PREKEY_U and a count value CMAC_KEY_COUNT, respectively. The count value CMAC_KEY_COUNT is used to differentiate new keys from the old ones. As an example, everytime when the MS moves from a location covered by a serving BS to a location covered by a target BS and performs handover to transfer the communication services from the serving BS to the target BS, the count value CMAC_KEY_COUNT is incremented for the new generation of the keys as illustrated above so as to assure the freshness of the keys.

In the WiMAX communication system, the BS is capable of establishing multiple service flows for the MS. In order to protect the traffic data transmission in each service flow, one or more Security Association (SA) is negotiated between the MS and the BS after network entry. An SA is identified by an SA identifier (SAID) and describes the cryptographic algorithms used to encrypt and decrypt the data traffic. As an example, the SA may be negotiated in an SA-TEK 3-way handshake stage. The MS could tell BS its capability in a request message SA-TEK-REQ, and the SA (including the SAID) established by the BS may be carried in a response message SA-TEK-RSP so as to be transmitted to the MS. It is noted that the MS may also obtain the SA in other specific way as known by the persons with ordinary skill in the art and the invention should not be limited thereto. For each SA, one or more TEK is generated and shared between the MS and the BS to be the encryption and decryption key in the cryptographic function. In IEEE 802.16e, the TEKs are randomly generated by the BS, and distributed to the MS in a secure way. However, as previously stated, the traffic data transmission is inevitably interrupted during the time period after a handover request message is sent and until the TEK is received and decrypted, wherein the long interruption time period seriously degrades the quality of the communication service. Thus, according to the embodiments of the invention, a novel TEK generation method and a substantially seamless handover procedure are provided.

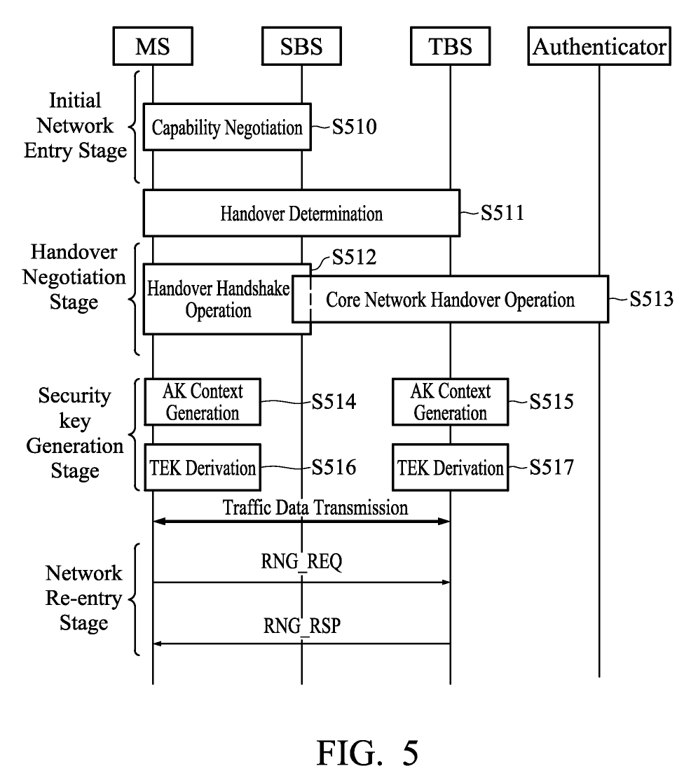

FIG. 5 shows a schematic diagram illustrating the initial network entry and handover operation procedures according to an embodiment of the invention. As shown in the figure, the SBS is a serving BS (such as the BS 101 shown in FIG. 1) that originally serves the MS (such as the MS 103 shown in FIG. 1), the TBS is a target BS (such as the BS 102 shown in FIG. 1) that the MS plans to handover the communication service to, and the Authenticator may be one of the network devices in the backbone network (such as the network device 107 shown in FIG. 1) for storing the security-related information and handling the security-related procedures in the communication system. The operations of the proposed TEK generation method and handover procedure in the initial network entry stage, handover negotiation stage, security key generation stage and network re-entry stage as shown in FIG. 5 will be illustrated in the following paragraphs. It should be noted that for simplicity, only the stages and the procedures involved by the proposed method and procedures will be discussed. For persons with ordinary skill in the art, it is easy to derive the non-discussed stages and procedures of FIG. 5, and the invention is not limited thereto. Thus, various alterations and modifications, without departing from the scope and spirit of the invention, may be appropriate. The scope of the present invention shall be defined and protected by the following claims and their equivalents.

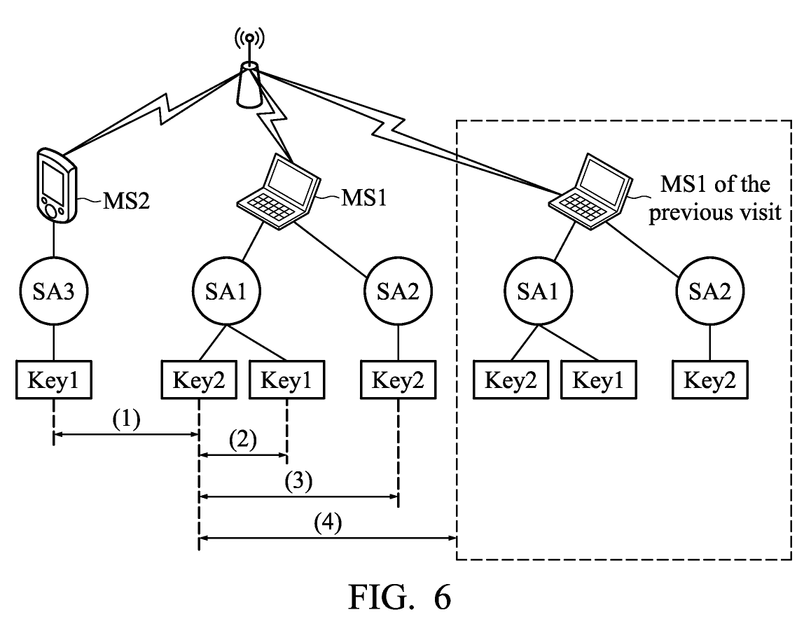

According to an embodiment of the invention, instead of randomly generating the TEKs by the TBS, after an SA is established, the MS and the TBS may generate the TEKs, respectively, without any message exchange therebetween before entering the network re-entry stage. As an example, the TEKs may be derived by the MS and the TBS, respectively, in the steps S516 and S517 as shown in FIG. 5. According to the embodiment of the invention, the TEKs may be generated according to a TEK derivation function to guarantee the uniqueness of the TEKs. FIG. 6 shows a schematic diagram of a communication network for illustrating the TEK generation concept according to an embodiment of the invention. In order to guarantee the uniqueness of the TEKs, it is preferably to make sure that the newly derived TEKs are different from (1) the TEKs of the other MSs connected to the same TBS, (2) the previous TEKs of the same SA in the same MS, (3) the TEKs of the other SAs in the same MS, and (4) the TEKs of the same SA in the same MS in the previous visit to the TBS. According to an embodiment of the invention, to achieve the four requirements described above, the TEK is preferably derived according to the secret key shared between the MS and the TBS and the information known by the MS and the TBS. As an example, according to the embodiment of the invention, the TEK derivation may be designed as:

TEK=Function(KEK,Sequence Number,SAID,CMAC_KEY_COUNT) Eq. 1

The function as introduced in Eq. 1 uses four input parameters KEK, Sequence Number, SAID and CMAC_KEY_COUNT to generate new TEKs. The input parameter KEK is the secret key shared between the BS and MS to guarantee that at a time, the TEKs are different between different MSs in the same BS. Since the KEK of a specific MS is different from the KEKs of the other MSs connecting to the same BS, the KEK may be used to distinguish between different MSs connecting to the BS. The input parameter Sequence Number is a count value incremented every time when a new TEK is generated to guarantee that for an SA, the newly generated TEK is different from the old TEKs. According to an embodiment of the invention, the TBS may reset the Sequence Number of the MS and let it start from zero in the TEK Derivation step S516 and S517 as shown in FIG. 5. Since the Sequence Number is incremented every time when a new TEK is generated, the TEK Sequence Number may be used to distinguish between different generations of the TEK of the same SA in the same MS. The input parameter SAID is the identifier for each SA to guarantee that the MS has different TEKs for different SAs. Since the SAID is an identifier of an SA established by the BS for the MS and corresponding to the TEK, the SAID may be used to distinguish between the TEKs of the different SAs in the same MS. The input parameter CMAC_KEY_COUNT is a count value used to differentiate new Cipher Message Authentication Code (CMAC) key from the old one so as to guarantee that for an MS, the TEKs are different in each handover to a TBS, even if the TBS has been visited during the AK lifetime as defined by the corresponding standards. As an example, the count value CMAC_KEY_COUNT may be incremented in each reentry of a BS and used to distinguish between different generations of message authentication keys in each reentry to the same BS. Since the count value CMAC_KEY_COUNT is a value used to distinguish between different generations of the keys of the AK context of the MS, the count value CMAC_KEY_COUNT may be used to guarantee that the derived TEK is different from TEKs of the same SA in the same MS in the previous visit to the TBS.

According to the embodiment of the invention, since the parameters KEK, Sequence Number, SAID and CMAC_KEY_COUNT may all be obtained at the MS and the TBS, the TEKs may be easily derived by the MS and the TBS without any message exchange after an SA is established. According to an embodiment of the invention, the TEK derivation function may use the KEK as the encryption key, and use the rest of the input parameters as the plaintext data in a cryptographic function. The cryptographic function may be the AES Electronic Code Book mode (AES-ECB), Triple-Data Encryption Standard (3-DES), International Data Encryption Algorithm (IDEA) . . . etc. As an example, the TEK derivation function may be expressed as:

TEK=AES_ECB(KEK,SAID|Sequence Number|CMAC_KEY_COUNT) Eq.2

, where the operation “|” represents the appending operation to append a following parameter to the tail of the pervious one. According to another embodiment of the invention, the TEK derivation function may also be expressed as:

TEK=AES_EDE(KEK,SAID|Sequence Number|CMAC_KEY_COUNT) Eq.3

According to yet another embodiment of the invention, the cryptographic function may also be the cryptographic function Dot16KDF as adopted by the WiMAX standards and the TEK derivation function may be expressed as:

TEK=Dot16KDF(KEK,SAID|Sequence Number|CMAC_KEY_COUNT, 128) Eq. 4

It should be noted that any cryptographic functions achieving substantially the same encryption results may also be applied here and thus, the invention should not be limited thereto.

According to an embodiment of the invention, since the TEK may be individually generated by the MS and the BS, it is preferably to negotiate the capability of a new TEK derivation in advance before performing the TEK derivation steps. Referring back to FIG. 5, in an initial network entry stage, the MS and the SBS communicate with each other to perform a plurality of network entry related procedures, including capability negotiation, authentication, registration, and so on. According to the embodiment of the invention, the MS and the SBS may inform each other of whether the TEK derivation is supported during handover in the initial network entry stage. As an example, the notification may be carried out in the capability negotiation step (step S510) as shown in FIG. 5. Conventionally, the capability negotiation is performed by transmitting the corresponding management messages to negotiate the basic capability supported by the MS and the BS. As an example, the MS may inform the BS about whether handover is supported by the MS via a corresponding flag carried in the corresponding negotiation message, what kinds of cipher functions are supported by the MS, and the BS may also inform the MS about whether handover is supported by the BS and what kinds of cipher functions are supported by the BS, correspondingly. Thus, according to the embodiment of the invention, the negotiation of the TEK derivation capability may be easily implemented by simply adding a flag to indicate the capability of the TEK derivation for the MS and the BS. Note that the flag for support of TEK derivation capability flag is not necessary named “TEK derivation support”. It can be other capability support flag including the support of the TEK derivation capability such as “seamless handover support”.

After the network entry stage, the MS begins to access the network and uses the services provided by the SBS. Assuming that the MS or the SBS determines to handover the MS to the TBS (step S511) according to some predetermined handover criteria defined by the corresponding specifications, a handover negotiation stage may be entered to perform the essential handover operations. In the handover negotiation stage, the MS and the SBS perform handover handshake operations (step S512) and the SBS, TBS and Authenticator perform Core Network handover operations (step S513). According to an embodiment of the invention, the SBS may inform the MS about the TEK derivation capability of the TBS during the handover handshake operations. As an example, the SBS may carry a flag indicating the TEK derivation capability of the TBS in a handover request message when the handover procedure is initiated by the SBS, or may carry the flag in a handover response message when the handover procedure is initiated by the MS. The TBS may also negotiate with the SBS and the Authenticator during the Core Network handover operations to obtain the information of the MS (which will be illustrated in detail in the following paragraphs). Note that the flag for support of TEK derivation capability flag is not necessary named “TEK derivation support”. It can be other capability support flag including the support of the TEK derivation capability such as “seamless handover support”.

According to an embodiment of the invention, after the handover negotiation is completed, a security key generation stage is entered. In the security key generation stage, the AK context may first be generated by the MS (step S514) and by the TBS (step S515), respectively. It should be noted, as those with ordinary skill in the art will readily appreciate, that the AK context may also be generated by the Authenticator or any other network devices in the Core Network (for example, in the Core Network handover operation step S513 as shown in FIG. 5), and forwarded to the TBS. Thus, the invention should not be limited thereto. According to the embodiment of the invention, the AK context may be updated according to the procedures as illustrated in FIG. 4 and the corresponding paragraphs. After the new AK context is generated, the TEK may be derived by the MS (step S516) and by the TBS (step S517), respectively, according to the TEK derivation functions as shown in Eq. 1 to Eq. 4, or the likes. When the TEKs are derived by the MS and the TBS, the traffic data transmission may begin. As an example, according to an embodiment of the invention, the MS may encrypts and/or decrypts the traffic data and transmits and/or receives the encrypted traffic data to and/or from the TBS before performing a handover procedure for the TBS in the network re-entry stage. Since the traffic data transmission may begin right after the TEKs are derived, a substantially seamless handover may be achieved. The reason why the traffic data transmission may begin right after the TEK derivation is because the essential information to identify the identity of the MS and TBS is already carried in the newly derived TEK via Eq. 1. Only the correct MS and TBS is able to decrypt the traffic data that has been encrypted by the newly derived TEK. According to an embodiment of the invention, the MS and the TBS may further confirm the identity of each other in the network re-entry stage. Because the ranging request message RNG_REQ and the ranging response message RNG_RSP carry plurality of parameters that may be used to authenticate the identity of the MS and the BS, the MS and the TBS may mutually verify the identity of each other. For example, the ranging request and ranging response messages may carry the MS identity, the count value CMAC_KEY_COUNT and a CMAC digest generated according to the message authentication keys CMAC_KEY_U and CMAC_KEY_D, where both of the count value CMAC_KEY_COUNT and the CMAC digest may be used to authenticate the sender. As an example, the CMAC digest may be derived via a Cipher-based Message Authentication Code (CMAC) function that calculates over some predetermined information by using a secret key CMAC_KEY_U as the message authentication key.

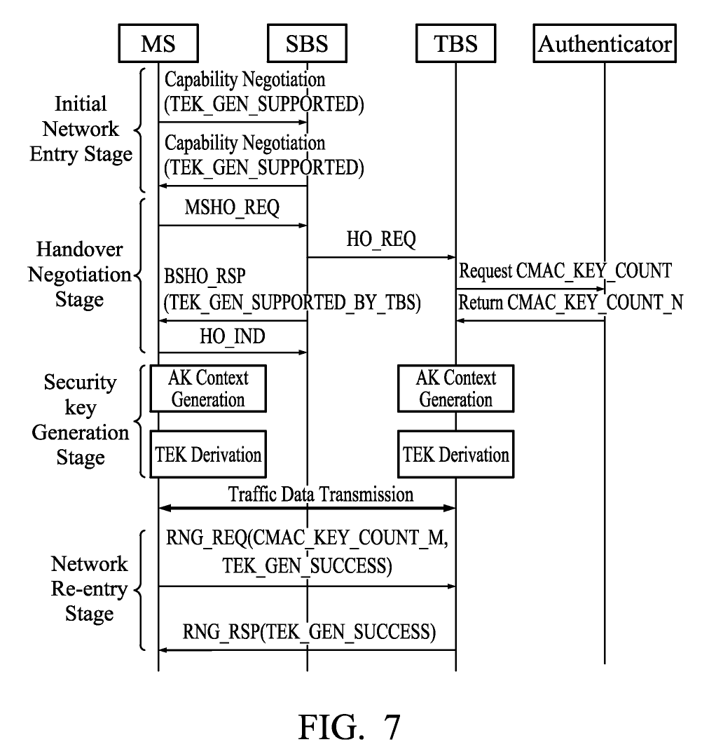

The confirmation in the handover negotiation stage is required because the handover messages may be lost due to unreliable radio links, or the new TEK may not have been successfully derived due to certain reasons. Thus, an error recovery procedure may further be performed in the network re-entry stage, if necessary. FIG. 7 to FIG. 11 show the message flows of initial network entry and handover operation procedures under different circumstances according to an embodiment of the invention. Referring to FIG. 7, MS initiated handover procedures are illustrated. The TEK derivation capability of the MS and the SBS is negotiated via the capability negotiation message in the initial network entry stage. As previously discussed, the MS may inform the SBS about whether the TEK derivation (or generation) is supported at the MS side via a flag TEK_GEN_SUPPORTED carried in the capability negotiation message. The SBS may also inform the MS about whether the TEK derivation is supported at the SBS side via the flag TEK_GEN_SUPPORTED carried in the capability negotiation message. When the MS determines that the signal quality of the SBS is becoming weaker and initiation of handover procedure is required, the MS sends a handover request message MSHO_REQ to the SBS. After receiving the MSHO_REQ message, the SBS performs Core Network handover operations with the TBS, the Authenticator and/or other network devices in the backbone network. During the Core Network handover operations, the SBS may inform the TBS of the handover requirement of the MS via the message HO_REQ, and may also be informed of whether the TEK derivation is supported at the TBS side via any response messages. The TBS may acquire the count value CMAC_KEY_COUNT of the MS from the Authenticator. The count value CMAC_KEY_COUNT recorded by the Authenticator is notated by CMAC_KEY_COUNT_N (N represents the network side). Those with ordinary skill in the art will readily appreciate that the Authenticator obtains the count value CMAC_KEY_COUNT of the MS (denoted as CMAC_KEY_COUNT_M, in which M represents the MS) after each successful authentication.

After the Core Network handover operations, the SBS responds to the handover request message by the message BSHO_RESP. According to an embodiment of the invention, the SBS may inform the MS about whether the TEK derivation is supported at the TBS side via the flag TEK_GEN_SUPPORTED_BY_TBS carried in the response message. Note that the flag for support of TEK derivation capability flag is not necessary named “TEK_GEN_SUPPORTED_BY_TBS”. It can be other capability support flag including the support of the TEK derivation capability such as “SEAMLESS_HO_SUPPORTED_BY_TBS”. The handover handshake is completed after the MS sends out a handover indication message HO_IND. According to an embodiment of the invention, the security key generation stage may be entered after the handover handshake is completed. The MS and the TBS may generate a new AK context according to the procedures as illustrated in FIG. 4, and may derive new TEKs according to the TEK derivation function as shown in Eq. 1 to Eq. 4, or the likes, respectively. The MS and TBS should keep the synchronization of CMAC_KEY_COUNT values used in deriving AK context and TEK values. For example, if the Authenticator sets CMAC_KEY_COUNT_N as the same value of CMAC_KEY_COUNT_M after each successful authentication and the MS increments CMAC_KEY_COUNT_M by one during each handover, the TBS should sets its CMAC_KEY_COUNT value (denoted as CMAC_KEY_COUNT_TBS) as CMAC_KEY_COUNT_N plus 1. After the TEKs are derived, the traffic data may be encrypted by the newly derived TEKs and the traffic data transmission may begin. Since the newly derived TEK are identical at the MS and the TBS sides by using synchronized input parameters, the encrypted traffic data may be decrypted and decoded correctly by the MS and the TBS, respectively.

According to an embodiment of the invention, a further identity confirmation is performed in the network re-entry stage. As an example, as shown in FIG. 7, a new flag TEK_GEN_SUCCESS may be added in the ranging request message RNG_REQ to indicate that the TEKs have been generated successfully at the MS by using the count value (CMAC_KEY_COUNT_M) carried in the ranging request message. Note that the flag for TEKs have not been generated is not necessary named “TEK_GEN_SUCCESS”. It can be other flag indicating that TEKs have been generated successfully such as “Seamless HO indication” in RNG-REQ message. The TBS may also inform the MS about whether the TEKs have been generated successfully via an additional flag. As an example, the TBS may inform the MS that the TEKs have been generated successfully at the TBS by using the count value carried in the ranging request message via the flag TEK_GEN_SUCCESS in the ranging response message RNG_RSP when the TBS verifies that the count value carried in the ranging request message equals to the count value CMAC_KEY_COUNT_TBS maintained by the TBS. Note that the flag for TEKs have been generated successfully is not necessary named “TEK_GEN_SUCCESS”. It can be other existing flags indicating that TEKs have been generated successfully such as HO optimization bits in RNG-RSP message.

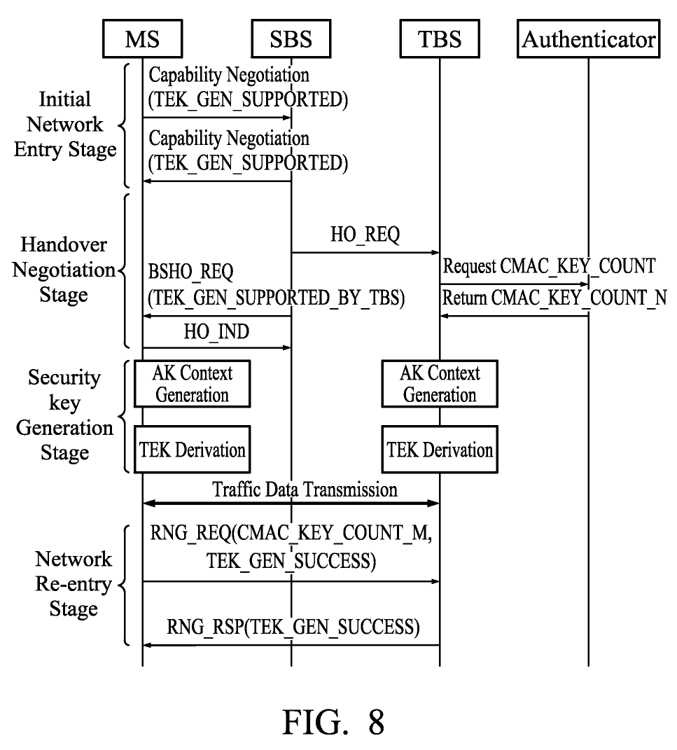

FIG. 8 shows the message flows of initial network entry and handover operation procedures according to an embodiment of the invention, wherein in this embodiment, the handover is initiated by the SBS. As previously discussed, the MS may inform the SBS about whether the TEK derivation (or generation) is supported at the MS side via a flag TEK_GEN_SUPPORTED carried in the capability negotiation message. The SBS may also inform the MS about whether the TEK derivation is supported at the SBS side via the flag TEK_GEN_SUPPORTED carried in the capability negotiation message. When the SBS determines that the signal quality of the MS is becoming weaker and determines initiation of the handover procedure, the SBS performs Core Network handover operations with the TBS, the Authenticator and/or other correlated network devices in the backbone network. In the Core Network handover operations, the SBS may inform the TBS of the handover requirement via the message HO_REQ, and may also be informed of whether the TEK derivation is supported at the TBS side via a response message. The TBS may acquire the count value CMAC_KEY_COUNT (and information about the value TEK sequence number) of the MS from the Authenticator. According to an embodiment of the invention, the SBS may inform the MS about whether the TEK derivation is supported at the TBS side via the flag TEK_GEN_SUPPORTED_BY_TBS carried in the handover request message BSHO_REQ. Note that the flag for support of TEK derivation capability flag is not necessary named “TEK_GEN_SUPPORTED_BY_TBS”. It can be other capability support flag including the support of the TEK derivation capability such as “SEAMLESS_HO_SUPPORTED_BY_TBS”. The handover handshake is completed after the MS sends out the handover indication message HO_IND.

According to an embodiment of the invention, the security key generation stage may be entered after the handover handshake is completed. The MS and the TBS generate new AK context according to the procedures as illustrated in FIG. 4, and derive new TEKs according to the TEK derivation function as shown in Eq. 1 to Eq. 4, or the likes, respectively. As previously illustrated, the count value CMAC_KEY_COUNT_M may be updated by the MS in the AK context generation step. MS and TBS should keep the synchronization of CMAC_KEY_COUNT_M and CMAC_KEY_COUNT_TBS used in AK context and TEK derivation. After the TEKs are derived, the traffic data may be encrypted by the newly derived TEKs and the traffic data transmission may begin. Since newly derived TEKs are identical at the MS and the TBS sides, the encrypted traffic data may be decrypted and decoded correctly by the MS and the TBS, respectively.

According to an embodiment of the invention, a further identity confirmation is performed in the network re-entry stage. As shown in FIG. 8, the flag TEK_GEN_SUCCESS (value is set to one) may be carried in the ranging request message RNG_REQ to indicate that the TEKs have been generated successfully at the MS by using the count value count value (CMAC_KEY_COUNT_M) carried in the ranging request message. The TBS may also inform the MS that the TEKs have been generated successfully at the TBS by using the count value carried in the ranging request message via the flag TEK_GEN_SUCCESS set to one in the ranging response message RNG_RSP when the TBS verifies that the count value carried in the ranging request message equals to the count value CMAC_KEY_COUNT_TBS maintained by the TBS. Note that the flag for TEKs have been generated successfully is not necessary named “TEK_GEN_SUCCESS”. It can be other existing flags indicating that TEKs have been generated successfully such as HO optimization bits in RNG-RSP message.

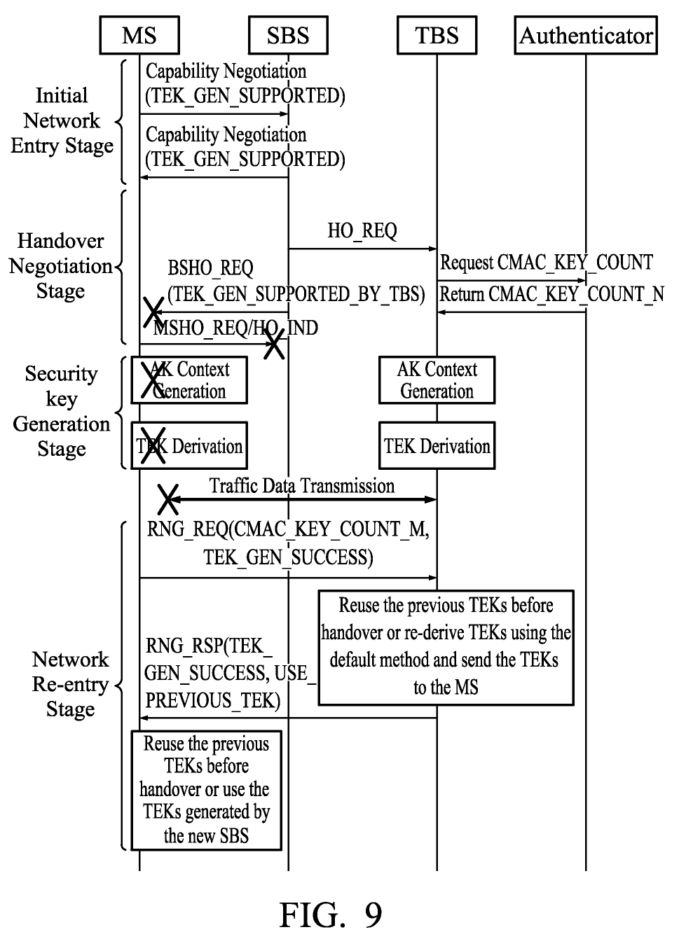

FIG. 9 shows the message flows of initial network entry and handover operation procedures according to an embodiment of the invention, wherein in this embodiment, the handover negotiation is uncompleted and error recovery procedure is applied. In the embodiment of the invention, for detailed descriptions of the capability negotiation, reference may also be made to FIG. 7 and FIG. 8. Thus, repeated descriptions are omitted hereafter for brevity. According to the embodiment of invention, both the MS and the SBS determine that the signal quality is becoming weaker and determine initiation of the handover procedure. However, the handover request and/or handover indication message(s) is unable to be propagated to the other sides due to bad network conditions. As shown in FIG. 9, the TBS is informed of the handover request from the SBS, but the MS is not aware of the handover request due to the transmission failure of the handover request messages BSHO_REQ and MSHO_REQ/HO_IND. After failure of several resending attempts of the handover request messages MSHO_REQ/HO_IND, the MS may give up the handover negotiation and directly connect to the TBS to handover the communication service to the TBS. In this case, the TBS generates a new AK context and derives new TEKs, but the MS does not generate a new AK context and derive new TEKs (the count value CMAC_KEY_COUNT_M may, however, still be incremented because of the handover operation). In this case, the traffic data transmission between the TBS and the MS may fail since the MS and TBS can not decrypt and decode the traffic data successfully with unsynchronized TEKs. Thus, in the network re-entry stage, a flag TEK_GEN_SUCCESS (value is set to zero to indicate no TEKs have been generated) may be carried in the ranging request message RNG_REQ to indicate that the TEKs have not been generated at the MS by using the count value (CMAC_KEY_COUNT_M) carried in the ranging request message. Note that the flag for TEKs have not been generated is not necessary named “TEK_GEN_SUCCESS”. It can be other flag indicating that TEKs have been generated successfully such as “Seamless HO indication” in RNG-REQ message.

After the TBS receives the ranging request message RNG_REQ with the flag TEK_GEN_SUCCESS set to zero, the TBS may decide whether to reuse the previous TEKs before handover, or re-generate TEKs by using the default method (for example, randomly generate) and send the newly derived TEKs to the MS. The TBS informs the MS that the TEKs have not been generated successfully at the TBS by using the count value carried in the ranging request message via the flag TEK_GEN_SUCCESS set to zero, and informs the MS about whether to use the previous TEKs before handover via the flag USE_PREVIOUS_TEK in the ranging response message RNG_RSP. After the MS receives the ranging response message, the MS determines whether to reuse the previous TEKs before handover or use the TEKs generated by the new SBS (i.e. the TBS shown in FIG. 9) according to the flag USE_PREVIOUS_TEK. In this manner, inconsistency errors of the TEK can be recovered in the network re-entry stage. Note that the flag for TEKs have not been generated is not necessary named “TEK_GEN_SUCCESS”. It can be other existing flags indicating that TEKs have been generated successfully such as HO optimization bits in RNG-RSP message.

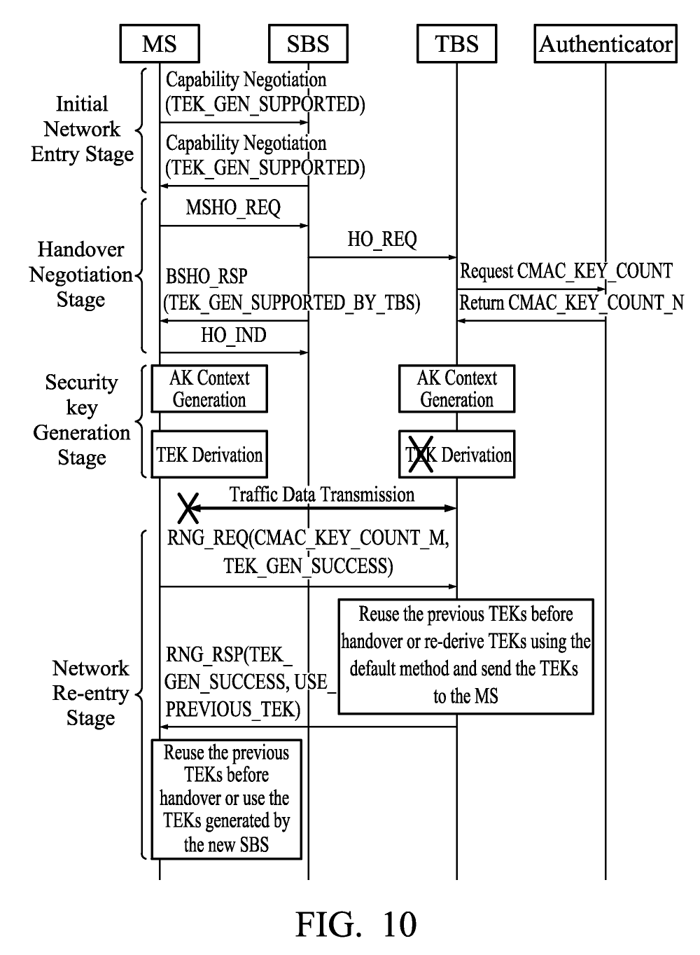

FIG. 10 shows the message flows of initial network entry and handover operation procedures according to an embodiment of the invention, wherein in this embodiment, the TEK derivation has failed and an error recovery procedure is applied. In the embodiment of the invention, for detailed descriptions of the capability negotiation and handover handshake, reference may also be made to FIG. 7 and FIG. 8. Thus, repeated descriptions are omitted hereafter for brevity. In the embodiment, the handover handshake in the handover negotiation stage is completed, but the TEKs derivation at the TBS side has failed. The failure of the new TEKs derivation causes traffic data transmission failure because the MS and TBS can not decrypt and decode the traffic data successfully.

Thus, when entering the network re-entry stage, a flag TEK_GEN_SUCCESS may be carried in the ranging request message RNG_REQ to indicate that the TEKs have been generated successfully at the MS by using the count value (CMAC_KEY_COUNT_M) carried in the ranging request message. However, since the TEKs have not been generated successfully at the TBS, the TBS may decide whether to reuse the previous TEKs before handover, or re-generate TEKs by using the default method and send the newly derived TEKs to the MS after receiving the ranging request message. The TBS informs the MS that the TEKs have not been generated successfully at the TBS by using the count value carried in the ranging request message via the flag TEK_GEN_SUCCESS set to zero, and informs the MS whether to use the previous TEKs before handover via the flag USE_PREVIOUS_TEK in the ranging response message RNG_RSP. After the MS receives the ranging response message, the MS determines whether to reuse the previous TEKs before handover or use the TEKs generated by the new SBS (i.e. the TBS shown in FIG. 10) according to the flag USE_PREVIOUS_TEK. In this manner, the TEK inconsistence error could be recovered in the network re-entry stage.

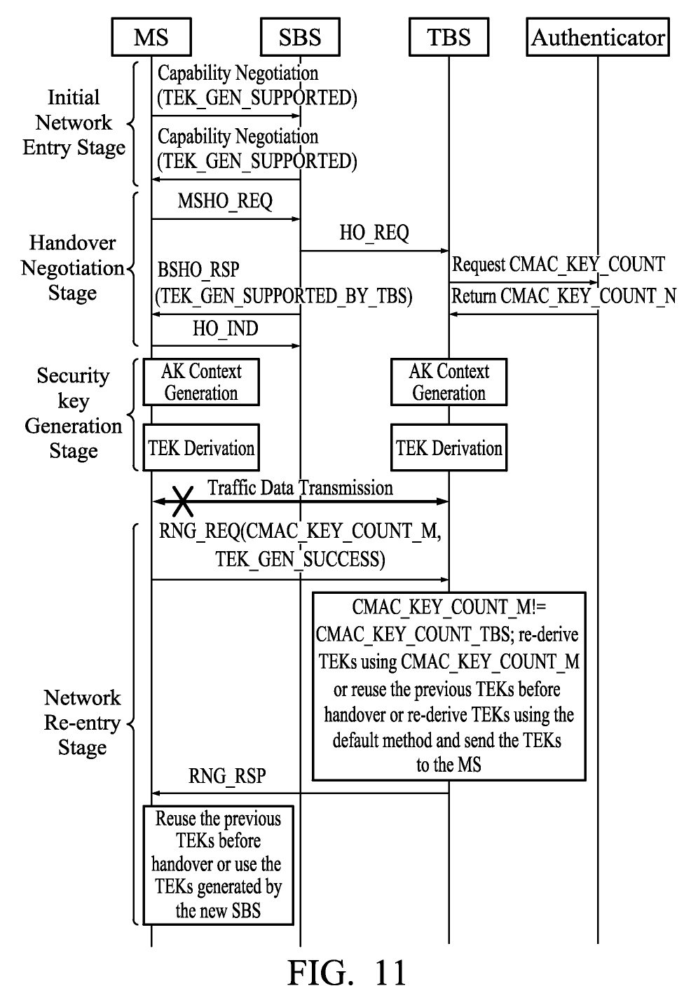

FIG. 11 shows the message flows of initial network entry and handover operation procedures according to an embodiment of the invention, wherein in this embodiment, the count values CMAC_KEY_COUNT_M and CMAC_KEY_COUNT_TBS are inconsistent and error recovery procedure is applied. In the embodiment of the invention, for detailed descriptions of the capability negotiation and handover negotiation, reference may also be made to FIG. 7 and FIG. 8. Thus, repeated descriptions are omitted hereafter for brevity. In the embodiment, the handover handshake in the handover negotiation stage is completed and the security key has been generated successfully by the MS and the TBS. However, the count values CMAC_KEY_COUNT_M and CMAC_KEY_COUNT_TBS obtained by the MS and the TBS are inconsistent. This may happen, for example, if the MS originally plans to handover to another BS, but eventually, discards its handover procedure plan. Since the count value CMAC_KEY_COUNT_M is updated every time when the MS plans to perform handover, whether the handover is performed successfully or not, the count value CMAC_KEY_COUNT_M may become unsynchronized with the count value CMAC_KEY_COUNT_N held at the network side. Thus, the TBS may get the unsynchronized count value and derive the TEKs with the unsynchronized count value. In this case, the TEKs derived by the MS and the TBS may be inconsistent and the traffic data transmission may fail because the MS and TBS can not decrypt and decode the traffic data successfully with different TEKs.

Thus, when entering the network re-entry stage, a flag TEK_GEN_SUCCESS may be carried in the ranging request message RNG_REQ to indicate that the TEKs have been generated successfully at the MS by using the count value (CMAC_KEY_COUNT_M) carried in the ranging request message. However, if the TBS determines that the count value CMAC_KEY_COUNT_M of the MS is larger than the count value CMAC_KEY_COUNT_TBS obtained by the TBS, the TBS next may decide whether to reuse the previous TEKs before handover, or re-derive TEKs using CMAC_KEY_COUNT_M according to the TEK derivation functions as shown in Eq. 1 to Eq. 4 or the likes, or re-generate TEKs by using the default method, and send the newly derived TEKs to the MS. The TBS informs the MS that the TEKs have not been generated successfully at the TBS by using the count value carried in the ranging request message via the flag TEK_GEN_SUCCESS set to zero, and informs the MS whether to use the previous TEKs before handover via the flag USE_PREVIOUS_TEK in the ranging response message RNG_RSP. After the MS receives the ranging response message, the MS determines whether to reuse the previous TEKs before handover or use the TEKs generated by the new SBS (i.e. the TBS shown in FIG. 11) according to the flag USE_PREVIOUS_TEK. In this manner, inconsistency errors of the count value can be recovered in the network re-entry stage.

As in FIG. 11, since the count value CMAC_KEY_COUNT may only be updated to the Core Network in the initial network entry stage and in the network re-entry stage, the count value CMAC_KEY_COUNT_M maintained by the MS and the count value CMAC_KEY_COUNT_TBS obtained by the TBS may be different. Therefore, the count value is preferably synchronized in advance. Referring back to FIG. 5, according to an embodiment of the invention, the MS may synchronize the count value CMAC_KEY_COUNT_M with the TBS in the handover handshake stage. According to an embodiment of the invention, the MS may transmit the count value CMAC_KEY_COUNT_M to any network device in the Core Network, and the network device then relay the count value to the TBS. According to another embodiment of the invention, the MS may transmit the count value CMAC_KEY_COUNT_M to the Authenticator, and then the Authenticator may relay the count value to the TBS.

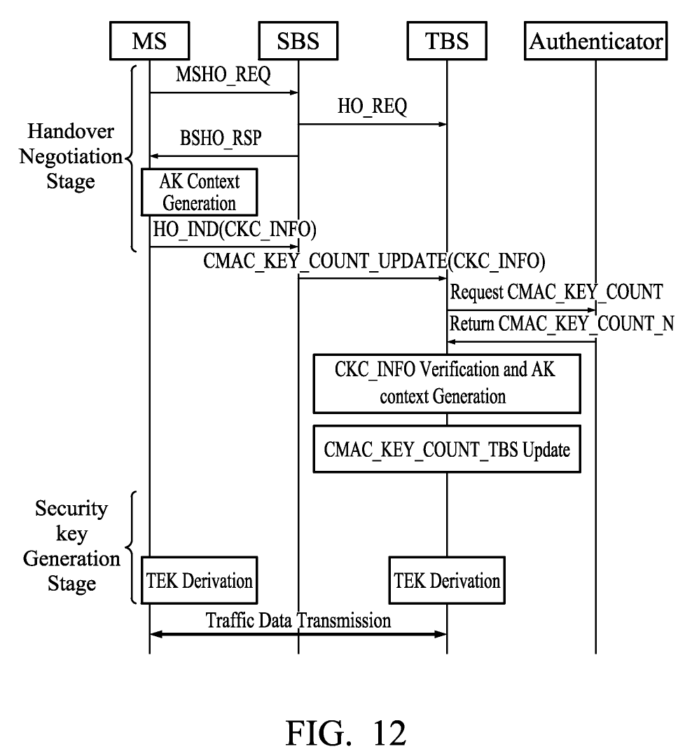

FIG. 12 shows the message flows of handover operation procedures according to an embodiment of the invention. According to the embodiment of the invention, the MS may generate a new AK context and update the count value CMAC_KEY_COUNT_M for the handover in the handover negotiation stage. The updated count value CMAC_KEY_COUNT_M may be transmitted to the SBS via the handover indication message, or transmitted to any other network device in the Core Network via the corresponding messages. The count value CMAC_KEY_COUNT_M may be further relayed by any network devices in the Core Network to finally arrive at the TBS side. As shown in FIG. 12, the SBS relays the information via an indication message CMAC_KEY_COUNT_UPDATE. According to the embodiment of the invention, since the TBS requires some information to confirm the integrity and origin of the CMAC_KEY_COUNT_M, proof of integrity provided by the MS may be carried with the count value CMAC_KEY_COUNT_M. As shown in FIG. 12, the MS may verify to the TBS that the count value CMAC_KEY_COUNT_M has been actually sent by the MS and has not been modified by any third party via the CKC_INFO carried in the handover indication message HO_IND. According to an embodiment of the invention, the CKC_INFO may be generated according to at least one secret key shared with the TBS and at least one information known by the TBS. As an example, the CKC_INFO may be obtained according to:

CKC_INFO=CMAC_KEY_COUNT_M|CKC_Digest Eq. 5

, where the CKC_Digest may be generated according to any secret key or information shared between the MS and the TBS, and the operation “|” means the appending operation. As an example, the CKC_Digest may be derived via a Cipher-based Message Authentication Code (CMAC) function that receives some shared information as the plaintext data and encrypts the information by using a secret key CMAC_KEY_U as the cipher key. The CKC_Digest may be obtained by:

CKC_Digest=CMAC(CMAC_KEY_U, AKID|CMAC_PN|CMAC_KEY_COUNT_M) Eq. 6

, where the AKID is the identity of the AK from which the CMAC_KEY_U is derived, and the CMAC_PN (CMAC Packet Number) is a counter for the CMAC_KEY_U which is incremented after each CMAC digest calculation.

After receiving the indication message CMAC_KEY_COUNT_UPDATE carrying information about the count value of the MS, the TBS may check the integrity and the origin of the count value to verify the authenticity of this information, and update the count value CMAC_KEY_COUNT_TBS when the received count value CMAC_KEY_COUNT_M passes the verification. The TBS may acquire the count value CMAC_KEY_COUNT_N from Core Network, and verify the CKC_Info by the obtained count value CMAC_KEY_COUNT_N. According to an embodiment of the information, the TBS first determines whether the obtained count value CMAC_KEY_COUNT_M is greater than or equal to the count value CMAC_KEY_COUNT_N. Since the count value CMAC_KEY_COUNT_M may be updated every time when the MS plans to perform a handover procedure, the count value CMAC_KEY_COUNT_M should be greater than or equal to the count value CMAC_KEY_COUNT_N uploaded to the Core Network in the initial network entry stage or network re-entry stage. When the CMAC_KEY_COUNT_M is greater than or equal to the count value CMAC_KEY_COUNT_N, the TBS derives the AK context with the received CMAC_KEY_COUNT_M, and verifies the integrity of the MS by using the key in the AK context. As an example, the TBS verify the CKC_Digest as shown in Eq. 6 by the message authentication key CMAC_KEY_U. The integrity and origin of CMAC_KEY_COUNT is guaranteed when the CKC_Digest can be verified by the key CMAC_KEY_U. The TBS updates the count value CMAC_KEY_COUNT_TBS by setting the count value CMAC_KEY_COUNT_TBS=CMAC_KEY_COUNT_M when the integrity of CMAC_KEY_COUNT_M is verified. Since the AK context is generated according to the synchronized count value CMAC_KEY_COUNT_TBS when verifying the CKC_Info, the TBS may derive the TEKs immediately following the verification and update step. The traffic data transmission may begin after the TEKs are respectively derived by the MS and the TBS according to the synchronized CMAC_KEY_COUNT_M and CMAC_KEY_COUNT_TBS. It should be noted, as those with ordinary skill in the art will readily appreciate, that the AK context may also be generated by the Authenticator or any other network devices in the Core Network, and forwarded to the TBS. Thus, the invention should not be limited thereto. Finally, the count value CMAC_KEY_COUNT_M may be updated to the Core Network in the Network re-entry stage (not shown).

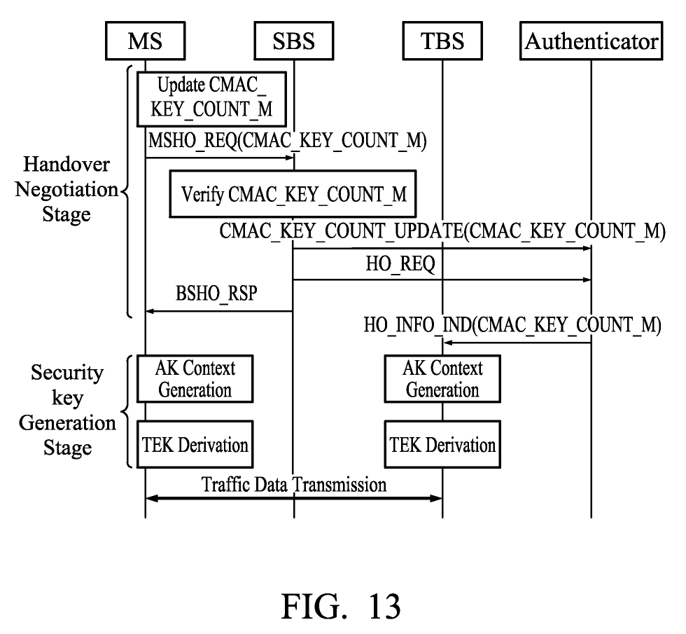

FIG. 13 shows the message flows of handover operation procedures according to another embodiment of the invention. According to the embodiment of the invention, the MS may update the count value CMAC_KEY_COUNT_M for the handover in the handover negotiation stage. The updated count value CMAC_KEY_COUNT_M may be transmitted to the SBS via the handover request message. The SBS may verify the count value CMAC_KEY_COUNT_M by determining whether the count value CMAC_KEY_COUNT_M is greater than or equal to the count value CMAC_KEY_COUNT_SBS maintained by the SBS. When the count value CMAC_KEY_COUNT_M is greater than or equal to the count value CMAC_KEY_COUNT_SBS, the SBS may further transmit the count value CMAC_KEY_COUNT_M to the Authenticator via any message. As an example, the SBS transmits the count value CMAC_KEY_COUNT_M via an indication message CMAC_KEY_COUNT_UPDATE to the Authenticator as shown in FIG. 13. The Authenticator may next forward the count value CMAC_KEY_COUNT_M to the TBS via, as an example, a HO_INFO_IND message. According to the embodiment of the invention, since the TBS trusts the Authenticator, the MS doesn't need to transmit any additional information to verify integrity. After the TBS receives the count value CMAC_KEY_COUNT_M of the MS, the TBS may generate the AK context and derive the TEKs according to the count value CMAC_KEY_COUNT_M. The traffic data transmission may begin after the TEKs are respectively derived by the MS and the TBS according to the synchronized count values. It should be noted, as those with ordinary skill in the art will readily appreciate, that the AK context may also be generated by the Authenticator or any other network devices in the Core Network, and forwarded to the TBS. Thus, the invention should not be limited thereto. Finally, the count value CMAC_KEY_COUNT_M may be updated to the Core Network in the Network re-entry stage (not shown). In this embodiment of the invention, since the count value CMAC_KEY_COUNT_TBS has been the synchronized with the count value CMAC_KEY_COUNT_M in advance, the TEKs derived by the MS and the TBS are consistent and the traffic data can be decrypted and decoded correctly.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A mobile station in a wireless communication network, comprising:
one or more radio transceiver module; and
a processor performing a handover negotiation procedure with a serving base station so as to handover communication services to a target base station by transmitting and receiving a plurality of handover negotiation messages via the radio transceiver module, and generating an Authorization Key (AK) context and deriving at least one Traffic Encryption Key (TEK) for the target base station, wherein the AK context comprises a plurality of keys shared with the target base station for encrypting messages to be transmitted to the target base station, and the TEK is a secret key shared with the target base station for encrypting traffic data.

2. The mobile station as claimed in claim 1, wherein the processor further encrypts and/or decrypts the traffic data and transmits and/or receives the encrypted traffic data to and/or from the target base station before performing a handover procedure for the target base station.

3. The mobile station as claimed in claim 1, wherein the processor further transmits a message to the target base station to authenticate its identity after deriving the TEK.

4. The mobile station as claimed in claim 1, wherein the processor derives the TEK according to at least one key in the AK context and information shared with the target base station.

5. The mobile station as claimed in claim 1, wherein the processor derives the TEK according to a fundamental key shared with the target base station, an identifier, a sequence number and a count value known by the target base station, wherein the fundamental key is a key to distinguish between different mobile stations connecting to the target base station, the identifier is an identifier of an association corresponding to the TEK and established by the target base station, the sequence number is a number to distinguish between different generations of the TEK and the count value is a value incremented in each reentry of the target base station and used to distinguish between different generations of message authentication keys in each reentry to the same target base station.

6. The mobile station as claimed in claim 5, wherein the fundamental key is a Key Encryption Key (KEK) in the AK context, and the identifier of the association is an identifier of a Security Association (SA).

7. The mobile station as claimed in claim 1, wherein the processor further transmits a count value, capable of distinguishing between different generations of message authentication keys in the AK context, to at least one network device in the wireless communication network via the radio transceiver module during a handover negotiation stage performing the handover negotiation procedure.

8. The mobile station as claimed in claim 7, wherein the processor transmits the count value to an authenticator handling security-related procedures in the wireless communication network so as to relay the count value via the authenticator to the target base station.

9. The mobile station as claimed in claim 7, wherein the processor further generates proof data to prove integrity and origin of the count value and transmits the proof data with the count value to the network device so as to relay the count value and the proof data via the network device to the target base station, and wherein the proof data is generated according to at least one key shared with the target base station and at least one information known by the target base station.

10. The mobile station as claimed in claim 9, wherein the proof data is generated by using the key in the AK context as the shared key and the count value as the protected information.

11. A method for generating at least one Traffic Encryption Key (TEK) shared between a mobile station and a base station in a wireless communication network, comprising:
obtaining at least one key and information shared between the mobile station and the base station; and
generating the TEK according to the information and the key via a predetermined function.

12. The method as claimed in claim 11, wherein the key is a fundamental key capable of being used to distinguish between different mobile stations connecting to the base station, and the information comprises a count value shared between the mobile station and the base station to distinguish between different generations of a plurality of message authentication keys of the mobile station.

13. The method as claimed in claim 11, wherein the key is a fundamental key capable of being used to distinguish between different mobile stations connecting to the base station, and the information comprises an identifier, a sequence number and a count value shared between the mobile station and the base station, wherein the identifier is an identifier of an association corresponding to the TEK and established by the base station for the mobile station, the sequence number is a number to distinguish between different generations of the TEKs and the count value is a value incremented in each reentry of the base station and used to distinguish between different generations of a plurality of message authentication keys in each reentry to the same base station.

14. The method as claimed in claim 13, wherein the fundamental key is a Key Encryption Key (KEK) shared between the mobile station and the base station, and the identifier is an identifier of a Security Association (SA).

15. The method as claimed in claim 13, wherein the predetermined function is a cryptographic function that receives the identifier, the sequence number and the count value as plaintext data, and encrypts the plaintext data by using the fundamental key.

16. A base station in a wireless communication network, comprising:
a network interface module;
one or more radio transceiver module; and
a processor receiving a handover indication message from a network device in the wireless communication network via the network interface module, generating an Authorization Key (AK) context and deriving at least one Traffic Encryption Key (TEK) for a mobile station after receiving the handover indication message, receiving an authentication message from the mobile station via the radio transceiver module, and verifying consistency of the TEK and a TEK generated by the mobile station according to the received authentication message,
wherein the handover indication message is a message to indicate that the communication service of the mobile station provided by the network device is to be transferred to the base station, the authentication message is a message for the mobile station to authenticate its identity, and the TEK is a secret key shared with the mobile station for encrypting traffic data.

17. The base station as claimed in claim 16, wherein the processor further encrypts and/or decrypts the traffic data by using the derived TEK.

18. The base station as claimed in claim 16, wherein the processor further transmits and/or receives the traffic data to and/or from the mobile station before receiving the authentication message in the network reentry procedure.

19. The base station as claimed in claim 16, wherein the AK context comprises a plurality of keys shared with the mobile station for protecting messages to be transmitted to the mobile station, and the processor derives the TEK according to at least one of the key and information known by the mobile station.

20. The base station as claimed in claim 16, wherein the processor verifies the consistency of the TEKs according to a count value carried in the authentication message, and wherein the count value is a value used to distinguish between different generations of message authentication keys in the AK context of the mobile station.

21. The base station as claimed in claim 16, wherein the processor derives the TEK according to a fundamental key shared with the mobile station, an identifier, a sequence number and a count value known by the mobile station, wherein the fundamental key is a key to distinguish between different mobile stations using the communication service provided by the processor, the identifier is an identifier of an security association corresponding to the TEK and established by the processor, the sequence number is a number to distinguish between different generations of the TEK of the mobile station and the count value is a value to distinguish between different generations of message authentication keys in AK context of the mobile station.

22. The base station as claimed in claim 21, wherein the processor further receives the count value and proof data, transmitted from the mobile station to the network device, to prove integrity of the count value, receives a reference count value from an authenticator handling security-related procedures in the wireless communication network, generates the AK context according to the count value, and verifies the correctness of the count value according to the generated AK context, the proof data and the reference count value before deriving the TEK, wherein the proof data was previously protected by the mobile station.

23. The base station as claimed in claim 21, wherein the processor further receives the count value from an authenticator handling security-related procedures in the wireless communication network, and wherein the count value was transmitted from the mobile station to the authenticator.
